(19) United States
(12) Patent Application Publication
(10) Pub. No.: US 2010/0055344 A1
(43) Pub. Date: Mar. 4, 2010

(54) Process for Producing a Sheet Steel Product Coated with an Anticorrosion System

(75) Inventors: Carmen Ostwald, Dortmund (DE); Manfred Meurer, Rheinberg (DE); Oliver Bendick, Herdecke (DE); Michael Keller, Freudenberg (DE); Erich Nabbefeld-Arnold, Wenden (DE)

Correspondence Address: PROSKAUER ROSE LLP, ONE INTERNATIONAL PLACE, BOSTON, MA, 02110, US

(73) Assignee: ThyssenKrupp Steel AG, Duisburg (DE)

(21) Appl. No.: 12/300,966

(22) PCT Filed: May 15, 2006
(86) PCT No.: PCT/EP2007/054712

§ 371 Date: Jun. 2, 2009

(30) Foreign Application Priority Data
May 15, 2006 (EP) 06113963.0

(51) Int. Cl. B05D 3/06; B05D 3/02; B05D 1/18; B05D 1/36

(52) U.S. Cl. 427/558; 427/321

(57) ABSTRACT

Economic production of highly corrosion-resistant flat steel products with a corrosion protection system, which are at the same time easy to process further, is described. The following work steps are applied: preheating the steel substrate to a strip temperature under inert gas atmosphere; cooling the steel substrate to the strip inlet temperature; hot dip coating of the steel substrate in a zinc bath so that a metallic corrosion protection coating is formed on the steel substrate which has an Al content of max 0.5 wt. % in an intermediate layer; adjusting the thickness of the metallic corrosion protection coating applied to the steel substrate in the melt bath to values of 3 to 20 μm per side by scraping away excess coating material; cooling the steel substrate with the metallic corrosion protection coating; and applying the organic coating to the metallic corrosion protection coating of the steel substrate.

### CROSS-REFERENCE TO RELATED APPLICATIONS

This application is a national phase application of international application no. PCT/EP2007/054712, filed on May 15, 2007, which claims the benefit of and priority to European patent application no. EP 06 113 963.0, filed May 15, 2006. The disclosures of the above applications are incorporated herein by reference in their entireties.

### FIELD OF THE INVENTION

The invention concerns a method for production of a flat steel product coated with a corrosion protection system in which a zinc-based coating is applied to a steel substrate such as a steel strip or sheet by means of hot dip coating and in which an organic coating is applied to the zinc-based coating.

### BACKGROUND

To improve the resistance to corrosion, in particular on steel sheets or strips, metallic coatings are applied which in the majority of applications are based on zinc or zinc alloys. Such zinc or zinc alloy coatings, because of their barrier and cathodic protective effect, provide good protection in practical use for the steel sheet coated in this way.

The corrosion resistance of zinc-coated sheet metal is further improved by application of organic coatings which in practice usually comprise lacquer systems constructed of several layers. One method for applying such a lacquer system to steel sheets with a zinc coating for example is described in WO 98/24857. According to this known method, the substrate surface is first cleaned. Then if necessary an organic and/or inorganic pre-treatment agent is applied to the coating. Then the coating layer prepared in this way is given a coating of a so-called primer as an adhesion promotion agent, on which in turn is applied, by means of spraying, dipping, scraping, rolling or spreading, a lacquer containing an amine-modified epoxy resin and a reticulation agent suitable for cross-linking. After application of this lacquer, this is baked and where necessary a removable or permanent film laid over the lacquer film to protect it from damage during transport or further processing, or to establish specific surface properties. The advantage achieved by this method is that with corresponding preparation of the coating surface, the primer shows little or no surface disruption and no adhesion problems occur. Substrates coated in this way therefore have good, even surface quality and are characterised by good formability, durability, resistance to chemical substances, corrosion and weathering.

In the prior art explained above, there is regularly a need for pre-treatment of a coating surface which has the disadvantage not only of associated cost but also in particular that the pre-treatment agent is usually harmful to the environment. One possibility for applying a lacquer system directly to the untreated surface without special pre-treatment is described in DE 103 00 751 A1. According to the method described in this publication, by the use of a suitable corrosion protection composition described in more detail in DE 103 00 751 A1, and while observing specific layer thicknesses and establishing a particular flexibility and adhesion strength of the coating, it is possible to produce, on a hot galvanised sheet with no further pre-treatment, a coating layer which is only 4-8 μm thick and which ensures a high corrosion resistance. However such methods, because of the complexity of the influences and operating parameters to be taken into account in their performance, are regarded as laborious and can only be implemented with difficulty under the crude operating conditions which usually predominate in practice.

### SUMMARY OF THE INVENTION

The invention, in one embodiment, allows economic production of highly corrosion-resistant flat steel products which at the same time are easy to process further.

The invention features a method for production of a flat steel product coated with a corrosion protection system in which a zinc-based coating is applied to a steel substrate such as a steel strip or sheet by means of hot dip coating, and in which an organic coating is applied to the zinc-based coating, in that such a method comprises the following work steps:
preheating the steel substrate in a preheating oven to a strip temperature of 720 to 850° C. under inert gas atmosphere;
cooling the steel substrate to a strip inlet temperature of 400-600° C.;
hot dip coating of the steel substrate under air exclusion in a zinc bath which contains, as well as zinc and unavoidable impurities, (in wt. %) 0.15-5% Al, 0.2-3% Mg and optionally in total up to 0.8% of one or more elements of the group Pb, Bi, Cd, Ti, B, Si, Cu, Ni, Co, Cr, Mn, Sn and rare earths, and with bath temperature of 420-500° C., wherein the difference between the strip immersion temperature and bath temperature varies in the range from −20° C. to +100° C., so that on the steel substrate a metallic corrosion protection coating is formed which (in wt. %) contains 0.25-2.5% Mg, 0.2-3.0% Al, ≦4.0% Fe and optionally in total up to 0.8% of one or more elements of the group Pb, Bi, Cd, Ti, B, Si, Cu, Ni, Co, Cr, Mn, Sn and rare earths, remainder zinc and unavoidable impurities and which has an Al content of maximum 0.5 wt. % in an intermediate layer extending between a surface layer directly adjacent to the surface of the flat steel product and a border layer adjacent to the steel substrate and with a thickness amounting to at least 20% of the total thickness of the corrosion protection coating;
adjusting the thickness of the metallic corrosion protection coating applied to the steel substrate in the melt bath to values of 3-20 μm per side by scraping away excess coating material;
cooling the steel substrate with the metallic corrosion protection coating; and
Applying the organic coating to the metallic corrosion protection coating of the steel substrate.

A steel substrate present in the form of a fine steel sheet or strip is subject to a coating process, the work steps of which, with regard to the economics of large scale implementation, are preferably performed in continuous passage. The through speeds set in practice can, depending on the efficiency and time required for the processing step concerned, lie in the range of 60-150 m/min.

First, the steel substrate is preheated. Preheating can be carried out for example in a preheating oven of the type DFF (Direct Fired Furnace) or RTF (Radiant Tube Furnace). In order to prevent oxidation of the surface of the steel substrate on heating, the annealing concerned is performed under inert gas which in the known manner can have a hydrogen proportion of at least 3.5 vol. % to typically 75 vol. %.

In order to prepare the steel substrate optimally for the subsequent coating step, the maximum strip temperature achieved, depending on steel type, is set at 720 to 850° C.

After heating the steel substrate enters the zinc bath under air exclusion. This can be achieved in the known manner for example by introducing the substrate into the melt bath through a blow pipe connected with the interior of the annealing furnace and with its opening submerged in the melt bath.

The melt bath comprises a melt which, as well as zinc and the usual production-induced impurities, has contents of magnesium and aluminium. The composition of the melt is chosen so that on the steel substrate a metallic corrosion protection coating containing Zn—Mg—Al—Fe is formed. Because of the distribution of the alloy elements it contains, this has firstly optimum adhesion to the steel substrate and secondly a surface composition which is suitable for direct application of an organic coating without complex pre-treatment. At the same time the coating has excellent weldability which makes the flat steel products suitable for spot welding.

The layer structure of the coating can be formed so that in its surface border layer directly adjacent to the surface, the thickness of which is restricted to max 10% of the total thickness of the coating, the elements Mg and Al are initially present enriched as oxides. In addition Zn oxide is present at the surface. The amount of Al enrichment at the immediate surface is maximum approx 1 wt. %. The oxide layer formed on the zinc alloy coating passivates the surface and allows direct lacquer adhesion.

The thinner the surface border layer, the better the coatability and weldability of the metal corrosion protection coating produced in the hot dip method. Therefore the operating parameters for the zinc dip coating are preferably set so that the thickness of the surface border layer is less than 5%, in particular less than 1% of the total thickness of the metal coating.

Next to the surface border layer, up to a thickness of at least 25% of the total thickness of the coating, is an intermediate layer with Al content of maximum 0.25 wt. %. In its border layer adjacent firstly to the intermediate layer and secondly to the steel substrate, the Al content then rises to 4.5% at the border to the steel substrate. The Mg enrichment at the immediate surface of the coating is clearly greater than the Al enrichment. Here Mg proportions of up to 10% are reached. Thereafter the Mg proportion diminishes over the intermediate layer and, at a depth of around 25% of the total layer thickness of the coating, amounts to 0.5 to 2%. Over the border layer there is a rise in Mg content in the direction of the steel substrate. At the border to the steel substrate the Mg content is up to 3.5%. The low Al content in the intermediate layer guarantees particularly good weldability and even formation of the surface, while the Fe alloyed into the border layer ensures particularly good adhesion of the coating to the steel substrate. The excellent corrosion protection effect of the coating also achieved with low coating thicknesses is guaranteed by the high content of Mg and Al in the border layer.

The data given here and in the claims on the structure of the corrosion protection coating and its individual layers relate to a layer profile determined by GDOS measurement (glow discharge optical emission spectrometry). The GDOS measurement method described for example in the VDI Glossary of Material Technology, issued by Hubert Grafen, VDI-Verlag GmbH, Düsseldorf, 1993, is a standard method for rapid detection of a concentration profile of coatings.

In particular the properties listed above are achieved with a metallic corrosion protection coating produced if the Al content of the melt bath is 0.15-0.4 wt. %. It has been found that with such relatively low Al contents of a melt bath used in the method for carrying out the invention, suitable setting of the strip immersion and/or bath temperature itself can directly influence the structure of the desired layer system.

During the hot dip coating, it is achieved that high Al and Mg contents are enriched in the border layer of the metallic corrosion protection coating adjacent to the steel substrate, whereas in the intermediate layer in particular low Al contents are present. The difference between the temperature of the strip on immersion and the temperature of the melt bath has a particular significance. As this difference varies in the range from −20° C. to 100° C., preferably −10° C. to 70° C., the minimised presence of Al in the intermediate layer can be set securely and in a targeted manner.

To support further the formation of the layer structure of the metallic corrosion protection coating to be set, the Mg content of the melt bath can be restricted to 0.2 to 2.0 wt. %, in particular 0.5 to 1.5 wt. %. Elements of the group Pb, Bi, Cd, Ti, B, Si, Cu, Ni, Co, Cr, Mn, Sn and rare earths can be present in a corrosion protection coating produced up to a total content of 0.8 wt. % in the coating. Pb, Bi and Cd serve to form a larger crystal structure (flower of zinc), Ti, B, Si to improve formability, Cu, Ni, Co, Cr, Mn to influence the border layer reactions, Sn to influence the surface oxidation and rare earths, in particular lanthanum and cerium, to improve the flow behaviour of the melt. The impurities which may be contained in a corrosion protection coating include the constituents which enter the surface coating from the steel substrate as a result of the hot dip coating in quantities which do not influence the properties of the surface coating.

After passing through the galvanising part, the thickness of the surface coating is set to 3-20 μm which corresponds to a coating mass of the metallic corrosion protection coating of 20-140 g/m² per side. The excellent corrosion protection effect of coatings formed allows the thickness of the coating to be restricted to values of 4-12 μm, which corresponds to a coating mass of 30-85 g/m² per side. Steel substrates with such thin coatings can be processed further particularly well.

The scraping away of excess surface coating material to set the coating thickness can for example be achieved in the known manner by means of gas jets applied by a nozzle scraper system. The gas for the gas jets is preferably nitrogen in order to limit as far as possible any oxidation of the surface of the coating.

After the steel strip with the zinc-based metallic corrosion protection coating containing Mg and Al has been guided out of the zinc bath, it is cooled in a targeted manner. The final temperature reached typically corresponds to room temperature.

Then the steel substrate with the metallic corrosion protection coating can be subjected to temper rolling in order to achieve a surface texturing optimally suited to the subsequent coating. Both the controlled cooling and any temper rolling performed are carried out preferably, with regard to economics and efficiency, in line and in a continuous passage with the galvanising process.

Finally, the steel substrate coated in the manner of the invention is organically coated. This can take place in a separate strip coating plant or also in line directly after cooling and/or any necessary additional tempering. A process following continuously after the preceding work step is favourable here because then the coating can be applied directly to the freshly produced metallic surface with particularly good working results. In particular, when the organic coating follows the preceding work step in line, it avoids the metallic coating being changed by ageing, oiling or degreasing.

In principle however it is also conceivable for the organic coating to be applied in the known manner discontinuously via a separate coil coating plant. To this end the steel substrate fitted with the coating can, after galvanising, cooling or rolling, first be oiled to guarantee a temporary corrosion protection.

A further variant is “sealing” of the substrate and galvanising. For this a layer approximately 2 μm thick made of polyacrylate or polyester is applied as simple corrosion protection and as a further processing aid which, inter alia, can be applied with thermal or UV hardening.

Surprisingly it has been found that the surface present immediately after the galvanising step without cleaning and pre-treatment and not influenced by further processing steps, is particularly suited for direct application of the organic coating. When cleaning of the surface of the coating is performed, a mild cleaning has proved suitable so that the native oxide layer existing on the metallic coating is subject to minimum attack. The term “mild cleaning” in this context refers to cleaning in which the surface of the metallic corrosion protection coating is treated with a mild alkali cleaning agent (pH value 9-10, free alkalinity up to 14) or a strong alkali (pH value 12-12.5, free alkalinity 5) but low concentrate cleaning agent. Cleaning agents suitable for this purpose are for example fluids based on phosphate-containing potassium or sodium lye, the temperature of which typically lies in the range from 40-70° C.

Before application of the organic coating by means of spraying, dipping or using a roll coater, pre-treatment can be applied to the strip surface which passivates the metallic surface and ensures adhesion between the metal coating and the lacquer. This pre-treatment is preferably a system free from Cr^{VI}, preferably a pre-treatment totally free from Cr, which for example is produced on a basis of Ti, Zr, P and/or Si. As the native oxide layers which are created on the steel substrate carrying the coating already guarantee excellent passivation of the surface, in many applications important in practice, however, such pre-treatment may be completely omitted and the lacquer applied directly to the metallic substrate which has only been degreased.

The organic coating can be applied in the known manner in the form of at least one layer (lacquer and where applicable film) by means of roll coaters, spraying, dipping etc. In this way it is possible to form a single layer or multilayer structure in which the following layers or layer systems are implemented and where applicable can be combined:
1. Lacquer
2. Lacquer—film
3. Lacquer—film—lacquer
4. Lacquer (with and without adhesive)

This is followed by hardening of the coating by means of heat supply or radiation. With regard to the economics of the process, hardening by radiation, in particular UV radiation, is advantageous. Hardening by radiation requires no thermal afterburning of released solvents. Also a system for UV hardening can be implemented in a construction length which is substantially shorter than the length which would be required for a circulating air oven required for thermal drying.

Flat steel products produced with a metallic and an organic coating have, with reduced coating thickness, protection of open cut surfaces which is substantially better than that of conventionally coated steel substrates and improved migration properties at scratches and cut edges.

Where corresponding pre-treatment is necessary, using pre-treatment agents free from Cr^{VI}, the corrosion protection properties achieved are at least as good as in products which are pre-treated according to the prior art with agents containing Cr^{VI}.

### BRIEF DESCRIPTION OF THE DRAWINGS

The invention is now explained in more detail below with reference to embodiment examples in the drawings.

FIG. 1 shows a sequence of work steps of a first variant of a method for production of a flat steel product coated with a corrosion protection system;

FIG. 2 shows a sequence of work steps of a second variant of a method for production of a flat steel product coated with a corrosion protection system;

FIG. 3 shows a graphic depiction of the distribution determined by GDOS measurement of contents of Zn, Mg, Al and Fe over the thickness of a first corrosion protection coating applied to a steel substrate;

FIG. 4 shows a graphic depiction of the distribution determined by GDOS measurement of contents of Zn, Mg, Al and Fe over the thickness of a second corrosion protection coating applied to a steel substrate.

FIGS. 5-8 show layer structures of flat steel products with a corrosion protection coating.

### DESCRIPTION OF THE INVENTION

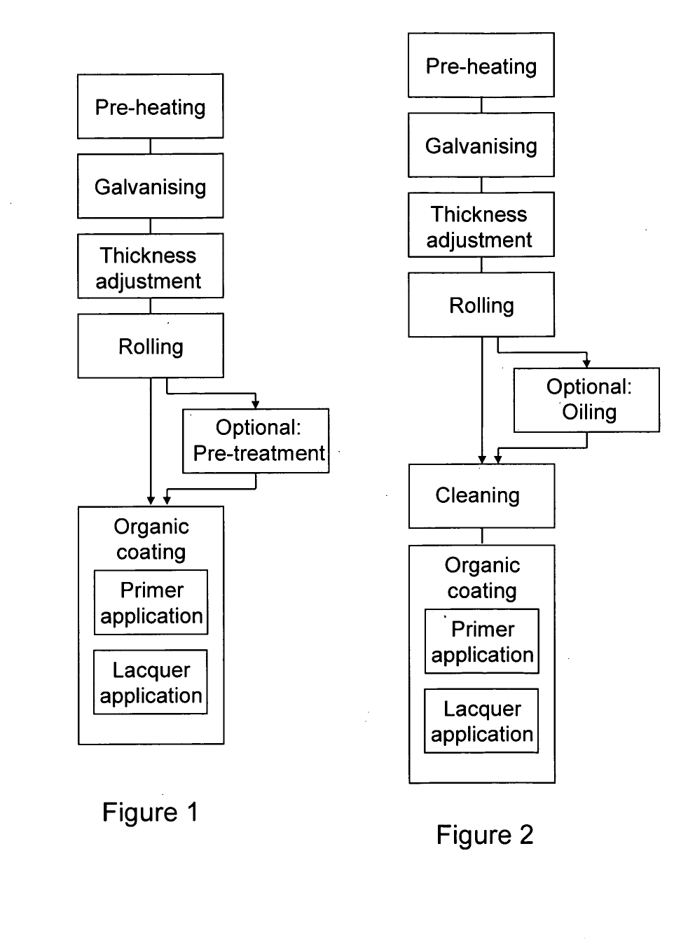

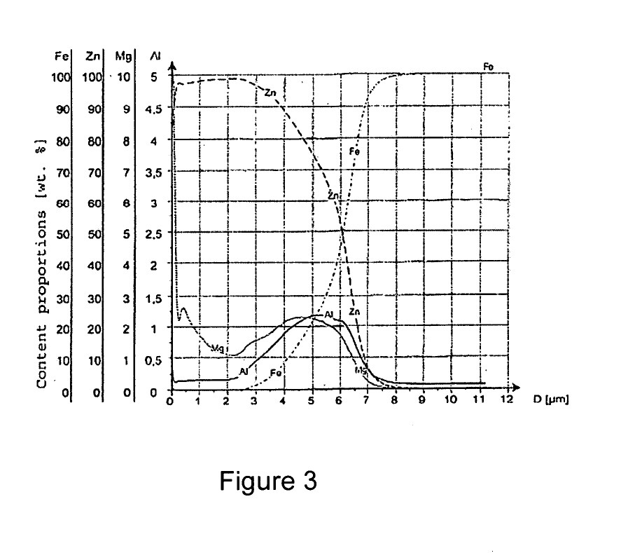

Two possible sequences within the framework of the invention of individual work steps are depicted graphically as examples in FIGS. 1 and 2.

In the variant shown in FIG. 1, all work steps are performed in a continuous passage. The steel substrate concerned (sheet or strip steel) is first preheated, then hot dip galvanised and, after setting the thickness of the metallic coating produced on the substrate, rolled to form an optimised surface structure with a low degree of deformation. Then an organic coating system formed from a primer and a lacquer is applied either directly onto the metallic corrosion protection coating without intermediate cleaning and preparation, or onto the metallic corrosion protection coating only after cleaning and where applicable pre-treatment following the rolling.

In the sequence shown in FIG. 2, the work steps “pre-heating”, “galvanising”, “thickness setting” and “rolling” are performed in a continuous passage, as in the method shown in FIG. 1. Then the steel substrate obtained after rolling, and coated with the corrosion protection coating, is first temporarily stored before—after cleaning of its surface to be provided with the organic coating—being coated in a separate coating plant with the organic coating system formed from primer and lacquer. In order to protect from corrosion during the waiting time the surface of the metallic corrosion protection coating which is to be coated organically, the metallic corrosion protection coating can be oiled or “sealed” after rolling.

Operating tests B1-B8 were performed in which steel strips comprising high-grade steel were used as steel substrates. The composition of the steel strips is given in table 1.

TABLE 1

| C | Si | Mn | P | S | Ti | Al | Fe, impurities |
|---|---|---|---|---|---|---|---|
| 0.07 | 0.04 | 0.40 | 0.012 | 0.005 | 0.005 | 0.04 | Remainder |

The operating parameters set during the operating tests, the respective melt bath composition and an analysis of the corrosion protection layer resulting on the steel substrate, are given in table 2.

The thickness of the surface border layer absorbing the superficial oxidation in the specimens tested was maximum 0.2 μm, and in relation to the layer profile determined by GDOS measurement, lay in the range of up to 2.7% of the total layer thickness. The amount of Al enrichment at the direct surface is maximum approximately 1 wt. %. This is followed up to a thickness of at least 25% of the total coating thickness by the intermediate layer with low Al content of maximum 0.25 wt. %. In the border layer then the Al content rises to 4.5% at the border to the steel substrate. The Mg enrichment at the immediate surface of the coating is clearly greater than the Al enrichment. Here Mg proportions of up to 20% are achieved. Thereafter the Mg proportion diminishes over the intermediate layer and at a depth of around 25% of the total layer thickness of the coating amounts to 0.5 to 2%. Over the border layer there is also a rise in Mg content in the direction of the steel substrate. At the border to the steel substrate the Mg content amounts to 3.5%.

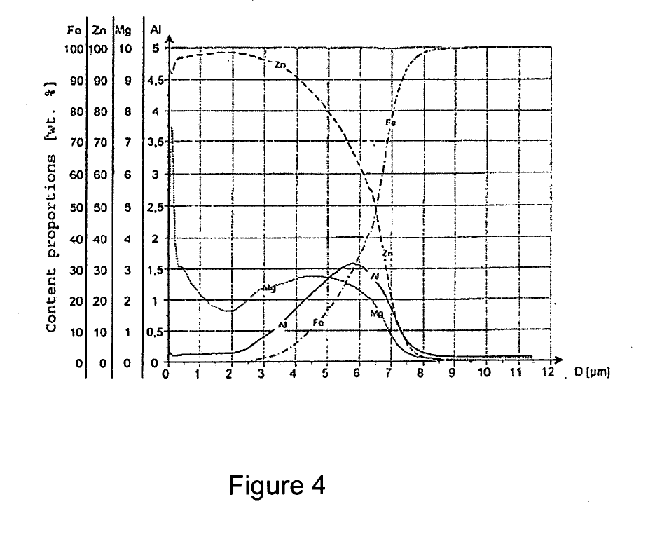

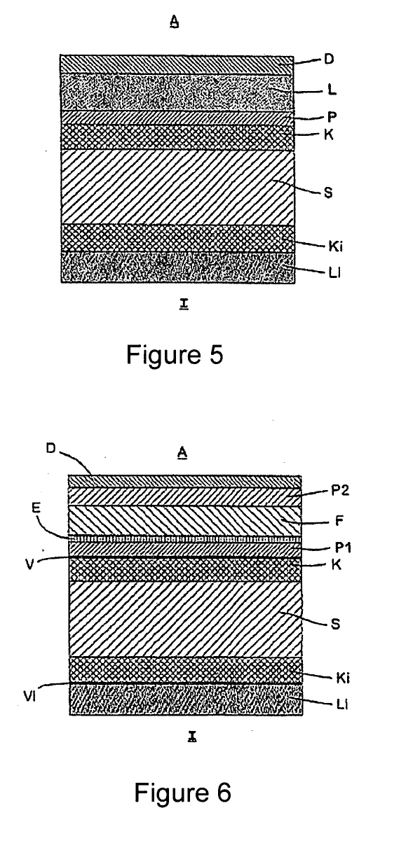

A corresponding distribution over the thickness D (surface D=0 μm) is depicted graphically as an example in FIGS. 3 and 4 which show the result of a GDOS measurement of two typical layer structures of metallic corrosion protection coatings produced on the steel substrate.

FIGS. 3 and 4 show that at the surface of the coating concerned, a surface border layer has formed with a high Al content as a result of oxidation. The thickness of this surface border layer is maximum 0.2 μm and is therefore easily broken in spot or laser welding without a deterioration in the quality of the welding result.

The surface border layer is followed by an intermediate layer approximately 2.5 μm thick with an Al content below 0.2%. The thickness of the intermediate layer is therefore around 36% of the total layer thickness of the corrosion protection coating of 7 μm.

The intermediate layer transforms into a border layer adjacent to the steel substrate in which the contents of Al, Mg and Fe have clearly risen over the corresponding contents of the intermediate layer.

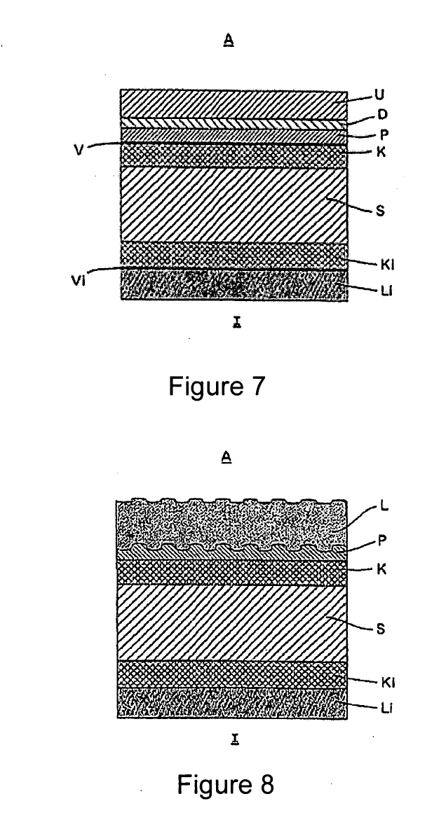

FIG. 5 shows, not to scale, a cross-section of part of a steel flat product produced and composed according to the invention. According to this on side A lying on the outside in use and particularly severely exposed to corrosive attack, of a steel substrate S present as steel sheet, firstly a metallic corrosion protection coating K approximately 7.5 μm thick is applied which essentially comprises Zn, Al, Mg and Fe.

Applied directly onto the surface of the corrosion protection coating K, i.e. without further pre-treatment, is a primer layer P. The thickness of the primer layer P with conventional primer products is around 5 μm. If so-called “thick layer primer” is used, the thickness of the primer layer P can be up to 20 μm.

On the primer layer P a lacquer layer L is applied with a thickness of approximately 20 μm. In preparation for the lacquer application and to shorten the total drying time, the primer layer P can first be pre-treated by means of UV radiation.

On the lacquer layer L is finally applied a cover lacquer coating D which is up to 17 μm thick. The primer layer P, lacquer layer L and cover lacquer layer D together form an organic coating which, together with the metallic corrosion protection coating K, despite the omission of pre-treatment of the surface of corrosion protection coating K, protect the steel substrate S particularly well against corrosion.

On the inside I in practical use, which is less severely attacked by corrosion, of the steel substrate S is also first applied a metallic corrosion protection coating Ki approximately 7.5 μm thick which essentially comprises Zn, Al, Mg and Fe. Directly onto the surface of the corrosion protection coating Ki is applied a lacquer layer Li of thickness 5 to 10 μm.

Flat steel products of the type shown in FIG. 5 are particularly suitable for use in the field of vehicle construction.

FIG. 6 shows, not to scale, a cross-section of part of a second flat steel product produced and composed according to the invention and particularly suitable also for use in the field of vehicle construction. According to this, on the outside in use, which is particularly exposed to corrosive attack, of the steel substrate S present as steel sheet, is firstly applied an approximately 5 μm thick metallic corrosion protection coating K which essentially comprises Zn, Al, Mg and Fe.

The surface of the corrosion protection coating K in this case has first been subjected to pre-treatment in which a thin pre-treatment coating V remains on the corrosion protection coating K. On the pre-treatment coating V is applied a primer layer P1 approximately 8 μm thick.

The primer layer P1 carries a layer of adhesive E approximately 5 μm thick, over which on the primer layer P1 is glued a laminated film F approximately 52 μm thick placed on adhesive layer E. On the outside of the laminated film F is applied a further primer layer P2, which again carries a cover lacquer layer D approximately 20 μm thick. The cover lacquer layer D forms the outer termination of the organic coating system formed from the primer layer P1, the adhesive layer E, the laminated film F, the primer layer P2 and the cover lacquer layer D.

On the inside in practical use, which is less severely attacked by corrosion, of the steel substrate S is also applied first a 5 μm thick metallic corrosion protection coating Ki which essentially comprises Zn, Al, Mg and Fe. The surface of the corrosion protection coating Ki in this case is first pre-treated to form a thin pre-treatment layer Vi. Then on the pre-treatment layer V is applied a lacquer layer Li which is typically 5 μm thick.

FIG. 7 shows, not to scale, a cross-section of part of a third flat steel product produced and composed according to the invention and particularly suitable for general external construction applications. According to this, on the outside in use, which is particularly exposed to corrosive attack, of the steel substrate S present as a steel sheet, is first applied an approximately 10 μm thick metallic corrosion protection coating K which essentially comprises Zn, Al, Mg and Fe. The surface of the corrosion protection coating K in this case too was first subject to pre-treatment in which a thin pre-treatment layer V remained on the corrosion protection coating K.

Applied to the pre-treatment layer V is applied a primer layer P approximately 5 μm thick, which in turn carries a 20 μm thick cover lacquer layer D.

The cover lacquer layer D itself carries on its outside a removable protection film U which protects the flat steel product during transport and storage.

The protective film U can however also be designed as a permanently adhering film to improve the surface properties.

On the inside in practical use, which is less severely attacked by corrosion, of the steel substrate S is also first applied an approximately 10 μm thick metallic corrosion protection coating Ki which essentially comprises Zn, Al, Mg and Fe. The surface of the corrosion protection coating Ki in this case too is first pre-treated to form a thin pre-treatment layer V. Then onto the pre-treatment layer V is applied a lacquer layer Li which is typically 7 to 15 μm thick.

FIG. 8 shows, not to scale, a cross-section of part of a fourth flat steel product produced and composed according to the invention and particularly suitable for domestic appliance construction. According to this, on the outside in use which is heavily exposed to corrosive attack, of a steel substrate S present as a steel sheet, is first applied an approximately 4 to 5 μm thick metallic corrosion protection coating K which essentially comprises Zn, Al, Mg and Fe.

Directly onto the surface of the corrosion protection coating K, i.e. without further pre-treatment, is applied a primer layer P approximately 8 μm thick. The primer used here is a so-called “structure primer” which forms a structured surface with protrusions and recesses.

On the primer layer P is then applied a lacquer layer L with a thickness of approximately 20 μm.

Where applicable, onto the lacquer layer can also be applied, for example, a permanently adhering protective layer which serves, inter alia, to improve the surface properties.

On the inside of the steel substrate S which is less severely attacked by corrosion, is also first applied an approximately 4 to 5 μm thick metallic corrosion protection coating Ki which essentially comprises Zn, Al, Mg and Fe. Directly onto the surface of the corrosion protection coating Ki is applied a lacquer layer Li with a thickness of 7 to 10 μm.

TABLE 2

| | Strip Inlet | Bath | Difference | Coating | Coating | | | | | |
|---|---|---|---|---|---|---|---|---|---|---|
| | Temperature | Temperature | BET − BT | Thickness | mass | Al | Fe | Mg | Al | Fe |
| Test | [° C.] | | | [μm] | [g/m²] | [wt. %] | | | [g/m²] | |
| B1 | 516 | 466 | 50 | 4.9 | 34.7 | 1.61 | 1.46 | 0.81 | 0.56 | 0.51 |
| B2 | 536 | 478 | 58 | 7.8 | 55.1 | 1.00 | 0.88 | 0.82 | 0.55 | 0.48 |
| B3 | 500 | 472 | 28 | 11.4 | 80.6 | 0.65 | 0.51 | 0.82 | 0.52 | 0.41 |
| B4 | 522 | 472 | 50 | 10.2 | 72.1 | 0.94 | 0.82 | 0.81 | 0.68 | 0.59 |
| B5 | 493 | 467 | 26 | 5.7 | 40.2 | 0.66 | 0.47 | 0.81 | 0.27 | 0.19 |
| B6 | 457 | 456 | 1 | 11.2 | 79.2 | 0.43 | 0.20 | 0.81 | 0.34 | 0.15 |
| B7 | 483 | 464 | 19 | 4.8 | 34.4 | 0.97 | 0.92 | 0.83 | 0.33 | 0.32 |
| B8 | 509 | 466 | 43 | 9.2 | 65.5 | 0.72 | 0.61 | 0.81 | 0.47 | 0.40 |

*) Remainder Zn and unavoidable impurities

1. A method for producing a flat steel product coated with a corrosion protection system, wherein a zinc-based coating is applied to a steel substrate by means of hot dip coating and an organic coating is applied to the zinc-based coating, comprising:
preheating the steel substrate in a preheating oven to a strip temperature of 720 to 850° C. under inert gas atmosphere;
cooling the steel substrate to a strip inlet temperature of 400 to 600° C.;
hot dip coating the steel substrate under air exclusion in a zinc bath including zinc and unavoidable impurities, (in wt. %) 0.15-5% Al, 0.2-3% Mg and optionally in total up to 0.8% of one or more elements of the group Pb, Bi, Cd, Ti, B, Si, Cu, Ni, Co, Cr, Mn, Sn and rare earths, and with a bath temperature of 420 to 500° C., wherein the difference between strip immersion temperature and bath temperature varies in the range from −20° C. to +100° C. so that on the steel substrate a metallic corrosion protection coating is formed which (in wt. %) contains 0.25 to 2.5% Mg, 0.2 to 3.0% Al, ≦4.0% Fe and optionally in total up to 0.8% of one or more elements of the group Pb, Bi, Cd, Ti, B, Si, Cu, Ni, Co, Cr, Mn, Sn and rare earths, remainder zinc and unavoidable impurities and which has an Al content of maximum 0.5 wt. % in an intermediate layer extending between a surface layer directly adjacent to the surface of the flat steel product and a border layer adjacent to the steel substrate and with a thickness amounting to at least 20% of the total thickness of the corrosion protection coating;
adjusting the thickness of the metallic corrosion protection coating applied to the steel substrate in the melt bath to values of 3 to 20 μm per side by scraping away excess coating material;
cooling the steel substrate with the metallic corrosion protection coating; and
applying the organic coating to the metallic corrosion protection coating of the steel substrate.

2. The method of claim 1 wherein the work steps can be performed in continuous passage.

3. The method of claim 2 wherein the speed with which the steel substrate passes through the work steps is in the range of 60-150 m/min.

4. The method of claim 1 wherein the difference between the strip immersion temperature and the bath temperature varies in the range from −10° C. to +70° C.

5. The method of claim 1 wherein the Al content of the zinc bath is 0.15 to 0.4 wt. %.

6. The method of claim 1 wherein the Mg content of the zinc bath is 0.2 to 2.0 wt. %.

7. The method of claim 1 wherein the Mg content of the zinc bath is 0.5 to 1.5 wt. %.

8. The method of claim 1 wherein the scraping of the excess coating material to produce the thickness of the Zn—Mg—Al coating takes place by means of gas jets.

9. The method of claim 8 wherein the gas used for the gas jets is nitrogen.

10. The method of claim 1 wherein the steel substrate with the Zn—Mg—Al coating is subjected to temper rolling.

11. The method of claim 1 wherein the thickness of the Zn—Mg—Al coating is set to 4-12 μm, corresponding to a coating mass of 30-85 g/m² per side.

12. The method of claim 1 wherein the organic coating is applied directly to the surface of the Zn—Mg—Al coating which was previously neither cleaned nor pre-treated and which is applied to the steel substrate.

13. The method of claim 1 wherein the surface of the Zn—Mg—Al coating applied to the steel substrate is cleaned before application of the organic coating.

14. The method of claim 1 wherein before application of the organic coating, a chemical pre-treatment is performed on the surface of the Zn—Mg—Al coating applied to the surface of the steel substrate, with a pre-treatment agent free from C^{VI}.

15. The method of claim 14 wherein the pre-treatment agent is free from Cr.

16. The method of claim 1 wherein the organic coating is hardened by means of UV radiation.

17. The method of claim 1 wherein the steel substrate comprises a steel strip or sheet.
